(19) United States
(12) Patent Application Publication
(10) Pub. No.: US 2016/0295036 A1
(43) Pub. Date: Oct. 6, 2016

(54) IMAGE PROCESSING DEVICE, IMAGE PROCESSING METHOD, PROGRAM, AND RECORDING MEDIUM

(71) Applicant: FUJIFILM Corporation, Tokyo (JP)

(72) Inventor: Yohei MOMOKI, Kanagawa (JP)

(73) Assignee: FUJIFILM Corporation, Tokyo (JP)

(21) Appl. No.: 15/045,654

(22) Filed: Feb. 17, 2016

(30) Foreign Application Priority Data
Mar. 30, 2015 (JP) 2015-067863

(51) Int. Cl. H04N 1/00; G06K 9/46

(52) U.S. Cl. CPC H04N 1/00196; G06K 9/46; H04N 1/00137; H04N 1/00161; H04N 1/00167; H04N 1/00307

(57) ABSTRACT

An image processing device and the like capable of reducing a retrieval time of a moving image corresponding to a captured image and enhancing retrieval accuracy thereof are provided. In the image processing device, an outline identification section identifies an outline of each still image included in a captured image acquired by capturing an output image of a composite image. A layout structure analysis section analyzes a layout structure of the plural still images included in the captured image based on information about each outline. A moving image specifying section that retrieves association information including a layout structure corresponding to the layout structure of the plural still images included in the captured image, from plural pieces of association information of composite images stored in a storage section, detects the result as first association information, and specifies each moving image associated with each still image included in the first association information.

### CROSS-REFERENCE TO RELATED APPLICATIONS

The present application claims priority under 35 U.S.C. §119 to Japanese Patent Application No. 2015-067863, filed Mar. 30, 2015, all of which are hereby expressly incorporated by reference into the present application.

### BACKGROUND OF THE INVENTION

1. Field of the Invention

The present invention relates to an image processing device, an image processing method, a program and a recording medium for reproducing and displaying moving images related to output images (printed matter) of a composite image including plural still images using an augmented reality (AR) technique.

2. Description of the Related Art

In recent years, portable terminals such as a smart phone or a tablet terminal have spread rapidly, and the number of still images (photographs) captured by these portable terminals has increased. In this regard, opportunities to capture a moving image have also increased. Recently, as a service that uses a moving image, as disclosed in “Moving image Photo! Service”, [online], Fujifilm Corporation, [Retrieved on Feb. 9, 2015], Internet <URL: http://fujifilm.jp/personal/print/photo/dogaphoto/>, a system that images (captures) printed matter such as a photograph using a portable terminal and then reproduces (AR-reproduces) a moving image related to the printed matter on a screen of the portable terminal using an AR technique has been proposed.

In such a system, the AR reproduction of the moving image related to the printed matter is performed according to the following steps (1) to (6).

(1) If a user selects a moving image to be printed from among plural moving images using a dedicated-use application operated on a portable terminal, the selected moving image is uploaded to a server.

(2) The server extracts frame images of a representative scene from the moving image uploaded from the portable terminal.

(3) The frame images of the representative scene extracted by the server are downloaded to the portable terminal.

(4) The user selects a frame image to be printed from among the frame images of the representative scene displayed as a list on a screen of the portable terminal, and makes a printing order.

(5) The server generates printed matter of the frame image of the representative scene ordered by the user, and performs image-processing for a moving image associated with the frame image for AR reproduction.

(6) After the delivered printed matter is imaged (captured) by the user using the portable terminal, the moving image for AR reproduction associated with the printed matter is downloaded from the server to be AR-reproduced on the screen of the portable terminal based on the AR technique.

In this system, when the printed matter is imaged (captured) in the portable terminal in step (6), similarity determination is performed between the captured image acquired by capturing the printed matter and the frame images extracted from the moving image, stored in the server. Further, when the frame image corresponding to the captured image is detected, the moving image associated with the frame image corresponding to the captured image is downloaded from the server, and AR reproduction is performed on the screen of the portable terminal by the AR technique.

However, if the number of frame images stored in the server is increased, a time necessary for the similarity determination, that is, a retrieval time for retrieving the moving image corresponding to the captured image is also increased according to the number of frame images.

Further, in this system, as a result of the similarity determination between the captured image and the frame image, in order to prevent reproduction of a moving image irrelevant to the captured image, for example, the user inputs an access key formed by a character string including numbers or letters. Thus, since the user uniquely knows the access key, the frame image corresponding to the captured image is detected from the frame images extracted from the moving image occupied by each user.

Thus, it is possible to prevent reproduction of a moving image irrelevant to the captured image, but there is a problem in that the user needs to input the access key whenever performing the AR reproduction.

Here, as related art techniques related to the invention, there are Japanese Patent No. 5073612 which relates to a panel layout method for arranging plural images on a predetermined output page in a predetermined order, JP2008-193197A which relates to a moving image delivery server that delivers data on a moving image stored in a web server to a portable communication terminal, JP2005-173897A which relates to an image processing technique that retrieves a desired image from plural still images and moving images, JP2003-216954A which relates to a moving image retrieval method or the like for efficiently performing retrieval of moving image information, and JP2006-234869A that relates to an image quality adjustment method for executing an image quality adjustment function when an image is output from an image output device.

### SUMMARY OF THE INVENTION

In order to solve the above problems, an object of the invention is to provide an image processing device, an image processing method, a program and a recording medium capable of reducing a retrieval time of a moving image corresponding to a captured image and improving retrieval accuracy thereof.

According to an aspect of the invention, there is provided an image processing device including: an outline identification section that identifies an outline of each still image included in a captured image acquired by capturing an output image of a composite image including a plurality of still images; a layout structure analysis section that analyzes a layout structure of the plurality of still images included in the captured image based on information about each outline identified by the outline identification section; a storage section that stores association information including the layout structure of the plurality of still images included in the composite image and information about each moving image associated with each still image included in the composite image, in association with the composite image; and a moving image specifying section that retrieves association information including a layout structure corresponding to the layout structure of the plurality of still images included in the captured image, analyzed by the layout structure analysis section, from a plurality of pieces of association information of composite images stored in the storage section, detects the result as first association information, and specifies each moving image associated with each still image included in the first association information.

It is preferable that the image processing device according to this aspect of the invention further includes: an image feature amount extraction section that extracts an image feature amount of each still image included in the captured image, corresponding to each outline identified by the outline identification section, in which the storage section further stores association information including information about the image feature amount of each still image included in the composite image in association with the composite image, and the moving image specifying section further retrieves, from the first association information, first association information including an image feature amount corresponding to the image feature amount extracted by the image feature amount extraction section, detects the result as second association information, and specifies each moving image associated with each still image included in the second association information.

In the image processing device according to this aspect of the invention, it is preferable that the image feature amount extraction section divides each still image included in the captured image into two or more separate regions and extracts an image feature amount of each separate region, the storage section stores association information including information about the image feature amount of each separate region of each still image included in the composite image, in association with the composite image, and the moving image specifying section retrieves, from the first association information, first association information including an image feature amount of each separate region corresponding to the image feature amount of each separate region extracted by the image feature amount extraction section and detects the result as second association information.

In the image processing device according to this aspect of the invention, it is preferable that when the captured image includes only a portion of still images among the plurality of still images included in the output image of the composite image, the moving image specifying section retrieves association information including a layout structure corresponding to a layout structure of only the portion of still images analyzed by the layout structure analysis section, from the plurality of pieces of association information of composite images stored in the storage section, and detects the result as first association information, and retrieves, from the first association information, first association information image features amounts corresponding to image feature amounts of only the portion of still images extracted by the image feature amount extraction section and detects the result as second association information.

It is preferable that the image processing device according to this aspect of the invention further includes: a frame image extraction section that extracts a plurality of frame images from a moving image; a composite image generation section that generates the composite image using two or more images including one or more frame images selected from among the plurality of frame images extracted by the frame image extraction section; and an output section that prints the composite image generated by the composite image generation section to output an output image.

It is preferable that the image processing device according to this aspect of the invention further includes: an association information generation section that generates, when the composite image is generated by the composite image generation section, the association information including the layout structure of the plurality of still images included in the composite image and the information about each moving image associated with each still image included in the composite image, in which the storage section stores the association information generated by the association information generation section in association with the composite image.

In the image processing device according to this aspect of the invention, it is preferable that the image feature amount extraction section extracts at least one of a main color tone, luminance, blurring, edges, and a subject person of each still image, as the image feature amount.

In the image processing device according to this aspect of the invention, it is preferable that the outline identification section identifies characteristics of the outlines including the number of the outlines, and an arrangement position, a size, and an aspect ratio of each outline.

In the image processing device according to this aspect of the invention, it is preferable that the layout structure analysis section sequentially divides the plurality of still images included in the composite image and the captured image using a binary tree to create a tree structure, to analyze the layout structure.

It is preferable that the image processing device according to this aspect of the invention further includes: an image capturing section that captures the output image of the composite image to acquire the captured image; a display section that displays, when the output image is captured by the image capturing section, the output image; and a control section that performs a control so that when the output image is captured by the image capturing section, each moving image associated with each still image included in the captured image, specified by the moving image specifying section, is reproduced in the outline of each still image included in the output image displayed in the display section.

In the image processing device according to this aspect of the invention, it is preferable that the control section performs a control so that when the output image is captured by the image capturing section, the output image is displayed in the display section and the respective moving images associated with the respective still images, specified by the moving image specifying section, are reproduced at the same time in the outlines of the respective still images included in the output image displayed in the display section.

In the image processing device according to this aspect of the invention, it is preferable that the control section performs a control so that when the output image is captured by the image capturing section, the output image is displayed in the display section and the respective moving images associated with the respective still images, specified by the moving image specifying section, are reproduced one by one in a predetermined order in the outlines of the respective still images included in the output image displayed in the display section.

In the image processing device according to this aspect of the invention, it is preferable that the control section performs a control so that when the output image is captured by the image capturing section, the output image is displayed in the display section and a moving image designated by a user among the respective moving images associated with the respective still images, specified by the moving image specifying section, is reproduced in the outline of each still image included in the output image displayed in the display section.

According to another aspect of the invention, there is provided an image processing method including: identifying an outline of each still image included in a captured image acquired by capturing an output image of a composite image including a plurality of still images, by an outline identification section; analyzing a layout structure of the plurality of still images included in the captured image based on information about each outline identified by the outline identification section, by a layout structure analysis section; and retrieving association information including a layout structure corresponding to the layout structure of the plurality of still images included in the captured image, analyzed by the layout structure analysis section, from a plurality of pieces of association information of composite images stored in a storage section that stores association information including the layout structure of the plurality of still images included in the composite image and information about each moving image associated with each still image included in the composite image, in association with the composite image, detecting the result as first association information, and specifying each moving image associated with each still image included in the first association information, by a moving image specifying section.

It is preferable that the image processing method according to this aspect of the invention further includes: extracting an image feature amount of each still image included in the captured image, corresponding to each outline identified by the outline identification section, by an image feature amount extraction section, in which the storage section further stores association information including information about the image feature amount of each still image included in the composite image in association with the composite image, and the moving image specifying section further retrieves, from the first association information, first association information including an image feature amount corresponding to the image feature amount extracted by the image feature amount extraction section, detects the result as second association information, and specifies each moving image associated with each still image included in the second association information.

In the image processing method according to this aspect of the invention, it is preferable that the image feature amount extraction section divides each still image included in the captured image into two or more separate regions and extracts an image feature amount of each separate region, the storage section stores association information including information about the image feature amount of each separate region of each still image included in the composite image, in association with the composite image, and the moving image specifying section retrieves, from the first association information, first association information including an image feature amount of each separate region corresponding to the image feature amount of each separate region extracted by the image feature amount extraction section and detects the result as second association information.

In the image processing method according to this aspect of the invention, it is preferable that when the captured image includes only some still images among the plurality of still images included in the composite image, the moving image specifying section retrieves association information including a layout structure corresponding to a layout structure of only the portion of still images analyzed by the layout structure analysis section, from the plurality of pieces of association information of composite images stored in the storage section, and detects the result as first association information, and retrieves, from the first association information, first association information including image features amounts corresponding to image feature amounts of only the portion of still images extracted by the image feature amount extraction section and detects the result as second association information.

According to still another aspect of the invention, there is provided a program that causes a computer to execute the steps of the above-described image processing method.

According to still another aspect of the invention, there is provided a computer-readable recording medium that stores a program that causes a computer to execute the steps of the above-described image processing method.

According to the invention, by retrieving association information using a layout structure of plural still images included in an output image of a composite image and an image feature amount of each still image, it is possible to specify a moving image corresponding to each still image. Thus, according to the invention, it is possible to greatly reduce time until a corresponding moving image is specified, compared with a case where a moving image corresponding to a still image is specified by performing similarity determination for the still images one by one, as in an image processing device in the related art.

Further, according to the invention, by retrieving the association information using the layout structure and the image feature amount, it is possible to enhance retrieval accuracy for specifying a corresponding moving image, compared with a case where moving images corresponding to still images are specified one by one, as in an image processing device in the related art. Thus, according to the invention, it is possible to save time for inputting an access key, to thereby enhance convenience. Further, since the retrieval accuracy is enhanced, the image feature amount extracted from each still image may be simpler than that in the related art.

### BRIEF DESCRIPTION OF THE DRAWINGS

FIG. 1 is a block diagram illustrating an embodiment of a configuration of an image processing device of the invention.

FIG. 2 is a block diagram illustrating an embodiment of a configuration of a server shown in FIG. 1.

FIG. 3 is a conceptual diagram illustrating an example of a state where plural still images included in a composite image and a captured image are sequentially divided using a binary tree to create a tree structure.

FIG. 4 is a conceptual diagram illustrating an example of a state where a moving image feature section retrieves association information corresponding to a captured image from plural pieces of association information.

FIG. 5 is a block diagram illustrating an embodiment of an internal configuration of a portable terminal shown in FIG. 1.

FIG. 6 is a flowchart illustrating an example of an operation of an image processing device when generating a composite image and association information and outputting an output image of the composite image.

FIG. 7 is a conceptual diagram illustrating an example of a state where moving images are transmitted to a server from a portable terminal.

FIG. 8 is a conceptual diagram illustrating an example of a state where frame images are extracted from moving images.

FIG. 9 is a conceptual diagram illustrating an example of a state where two or more images are selected from plural frame images.

FIG. 10 is a conceptual diagram illustrating an example of a state where a composite image is created using selected images.

FIG. 11 is a conceptual diagram illustrating an example of a layout structure of plural still images included in a composite image, an image feature amount of each still image, and a moving image associated with each still image.

FIG. 12 is a flowchart illustrating an example of an operation of the image processing device when reproducing and displaying, when a user captures an output image of a composite image, an AR reproduction moving image corresponding to the output image.

FIG. 13 is a conceptual diagram illustrating an example of a state where an output image of a composite image is captured by a portable terminal.

FIG. 14 is a conceptual diagram illustrating an example of a state where association information corresponding to a captured image is retrieved from plural pieces of association information of composite images.

FIG. 15 is a conceptual diagram illustrating an example of a state where a moving image corresponding to a still image is reproduced within an outline of the still image included in an output image of a composite image displayed in a display section of a portable terminal.

FIG. 16A is a conceptual diagram illustrating an example of a state where a captured image includes only a part of plural still images included in an output image of a composite image, and FIG. 16B is a conceptual diagram illustrating an example of a state where association information corresponding to the part of still images included in the captured image is retrieved.

### DESCRIPTION OF THE PREFERRED EMBODIMENTS

Hereinafter, an image processing device, an image processing method, a program, and a recording medium of the invention will be described in detail based on preferred embodiments shown in the accompanying drawings.

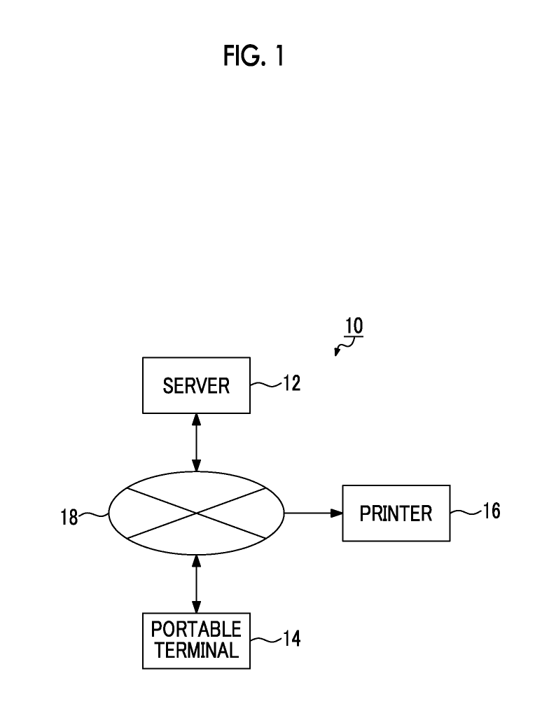

FIG. 1 is a block diagram illustrating an embodiment of a configuration of an image processing device of the invention. When an output image (printed matter) of a composite image including plural still images is captured, an image processing device 10 shown in FIG. 1 reproduces and displays a moving image associated with the output image. The image processing device 10 includes a server 12, a portable terminal 14, and a printer 16. The server 12, the portable terminal 14, and the printer 16 are connected to each other through a network 18 such as the Internet.

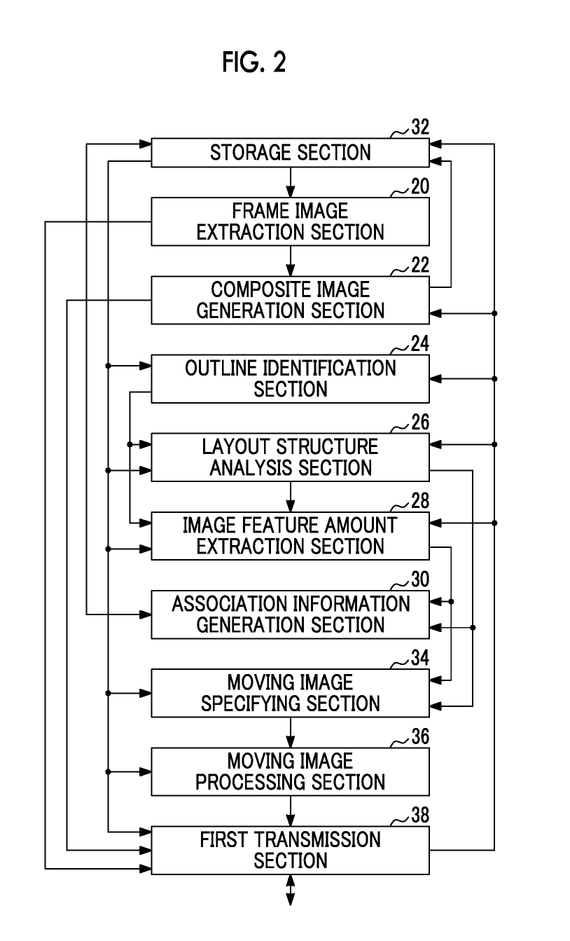

FIG. 2 is a block diagram illustrating an embodiment of a configuration of the server shown in FIG. 1. The server 12 shown in FIG. 2 includes a frame image extraction section 20, a composite image generation section 22, an outline identification section 24, a layout structure analysis section 26, an image feature amount extraction section 28, an association information generation section 30, a storage section 32, a moving image specifying section 34, a moving image processing section 36, and a first transmission section 38. One of more CPU (Central Processing Unit), which is not shown in the Figure, performs by loading various programs thereon, and acts as a frame image extraction section 20, a composite image generation section 22, an outline identification section 24, a layout structure analysis section 26, an image feature amount extraction section 28, an association information generation section 30, a storage section 32, a moving image specifying section 34, a moving image processing section 36, and a first transmission section 38.

The frame image extraction section 20 extracts plural frame images (one frame image that forms a moving image) from a moving image. Further, the frame image extraction section 20 generates thumbnail images from the extracted frame images.

Here, a method for extracting the frame images from the moving image is not particularly limited. For example, a user may manually extract desired frame images from a moving image, or frame images may be extracted from a moving image at a specific time interval.

Alternatively, using a key frame extraction (KFE) technique, a frame image which is a key in a scene change, for example, may be extracted. In the KFE technique, for example, each frame image of a moving image is analyzed, and a color tone, brightness, blurring, and the like of the frame image are detected. Then, a frame image before or after the color tone or brightness is greatly changed, or a frame image in which blurring does not occur due to appropriate exposure is extracted.

Further, a size, a direction, and an expression (a smiling face, a crying face, or the like) of the face of a person in a moving image may be detected, and a frame image may be extracted based on the detection result. Further, when sound is included in a moving image, a frame image may be extracted from the moving image before or after a time point (time code) when the sound becomes large. By extracting a frame image from a moving image using the above-described method, it is possible to extract a representative scene of the moving image as the frame image.

The composite image generation section 22 generates a composite image such as a photo book or a collage print using two or more images (selected images) including one or more frame images selected by a user of the portable terminal 14 from plural frame images extracted by the frame image extraction section 20.

Here, the photo book refers to a composite image in which a certain number of still images selected from plural still images occupied by a user are arranged on a certain number of pages in a certain layout, like photograph films. Further, the collage print refers to a composite image in which a certain number of still images selected from plural still images occupied by a user are arranged on one sheet of print in a certain layout. Further, the composite image may be any image that includes plural still images, or may include plural composite images like the photo book.

When a user captures an output image (printed matter) of a composite image to obtain a captured image, the outline identification section 24 identifies an outline of each still image included in the captured image.

Information about the outline identified by the outline identification section 24 is not particularly limited as long as it represents an outline characteristic, and may identify various outline characteristics. As the outline characteristics, for example, the outline identification section 24 may identify the number of outlines, an arrangement position, size, and aspect ratio of each outline, and the like.

Further, the shape of the outline is normally rectangular, but may not be rectangular such as a circular shape or a star shape. Even when the outline is faded, by differentiating a pixel value change in a captured image and setting a location where a differential value begins to change as an outline, it is possible to detect the outline. The outline may be inclined or may not be inclined with respect to a paper surface (mount) of a composite image. Further, when a frame is provided for a still image, whether to cause the frame to be included in the outline may be determined in advance.

When a captured image is acquired, the layout structure analysis section 26 analyzes a layout structure of plural still images included in the captured image based on information about respective outlines identified by the outline identification section 24.

The layout structure analysis section 26 may sequentially divide plural still images included in a composite image and a captured image using a binary tree to create a tree structure (logical structure), for example, to thereby analyze a layout structure.

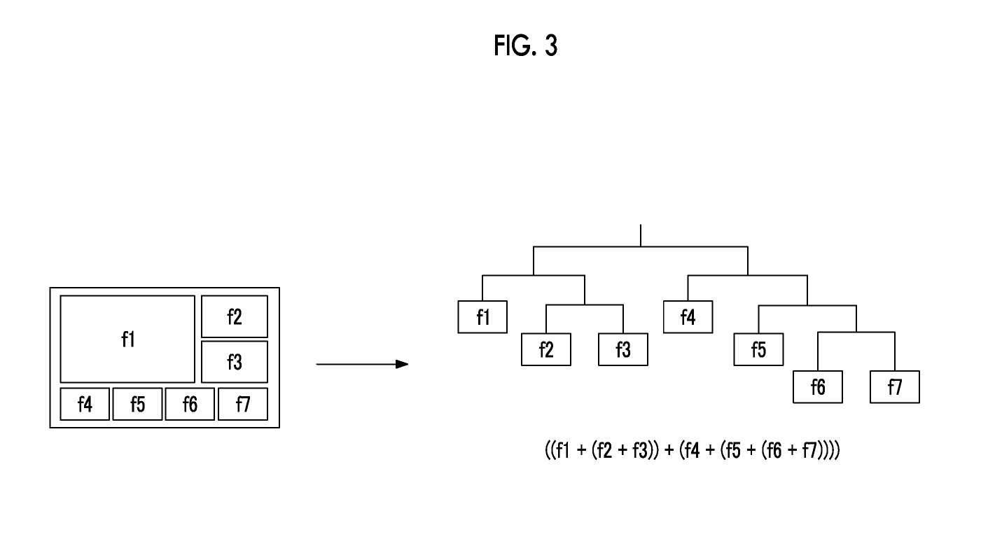

As shown on a left side in FIG. 3, when a composite includes seven still images f1 to f7, the layout structure analysis section 26 sequentially divides the seven still images f1 to f7 into two groups so that the number of still images included in one group is equal to or smaller than 2.

For example, the seven still images f1 to f7 are divided into a group of three still images f1 to f3 and a group of four still images f4 to f7 along the longest straight line capable of being divided into two groups.

Subsequently, the three still images f1 to f3 are similarly divided into a group of one still image f1 and a group of two still images f2 and f3.

Further, the group of the four still images f4 to f7 is first divided into one still image f4 and a group of three still images f5 to f7. Then, the three still images f5 to f7 are divided into one still image f5 and a group of two still images f6 and f7. As in this example, when four still images f4 to f7 having the same size and the same aspect ratio are arranged in a row or in a column, a division order or method may be appropriately determined.

As a result, as shown on a right side in FIG. 3, it is possible to create a tree structure of the seven still images f1 to f7. Further, the tree structure is expressed as a logical structure of ((f1+(f2+f3))+(f4+(f5+(f6+f7)))).

When a captured image is acquired, the image feature amount extraction section 28 performs image analysis of the captured image, and extracts an image feature amount of each still image included in the captured image, corresponding to each outline identified by the outline identification section 24.

Further, when a composite image is generated by the composite image generation section 22, the image feature amount extraction section 28 extracts an image feature amount of each still image included in the composite image.

The image feature amount of the still image is not particularly limited as long as it represents a feature of a still image, and various types of image feature amounts may be used. For example, the image feature amount extraction section 28 may extract at least one of a main color tone, brightness, blurring, edges, and a subject person of each still image as the image feature amount. For example, when the main color tone is extracted as the image feature amount, a histogram of a color included in the still image may be created, so that a color with a highest appearance frequency may be determined as the main color tone.

When a composite image is generated by the composite image generation section 22, the association information generation section 30 generates a layout structure of plural still images included in the composite image, an image feature amount of each still image included in the composite image, extracted by the image feature amount extraction section 28, and association information including information about each moving image associated with each still image included in the composite image.

The storage section 32 stores a variety of data. In the storage section 32, for example, a composite image generated by the composite image generation section 22, in addition to a moving image transmitted from the portable terminal 14, is stored, and association information generated by the association information generation section 30, or the like is stored in association with the composite image.

The moving image specifying section 34 retrieves association information including a layout structure corresponding to a layout structure of plural still images included in a captured image, analyzed by the layout structure analysis section 26, from plural pieces of association information about composite images stored in the storage section 32 and detects the result as first association information, retrieves first association information including an image feature amount corresponding to the image feature amount extracted by the image feature amount extraction section 28 from the first association information and detects the result as second association information, and specifies each moving image associated with each still image included in the second association information.

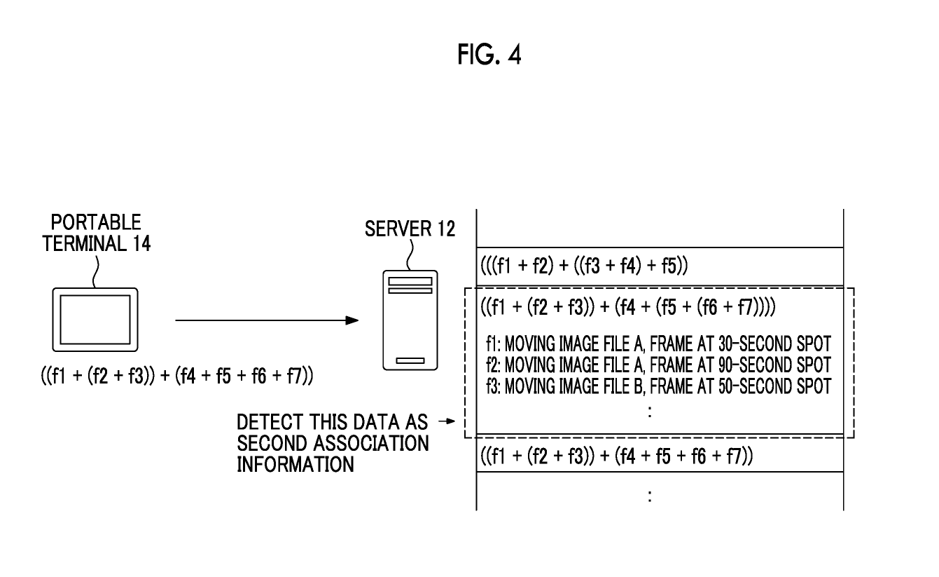

As shown in FIG. 4, for example, when the layout structure is expressed as the logical structure of ((f1+(f2+f3))+(f4+(f5+(f6+f7)))), and when the main color tone which is an image feature amount of each still image included in the captured image is green in the still images f1 and f2, is blue in the still images f3 to f5, and f7, and is red in the still image f6, the moving image specifying section 34 retrieves association information including the same logical structure of ((f1+(f2+f3))+(f4+(f5+(f6+f7))))) as a layout structure and detects the result as first association information, and retrieves first association information including the same main color tone which is green in the still images f1 and f2, is blue in the still images f3 to f5, and f7, and is red in the still image f6 as an image feature amount and detects the result as second association information.

As a result, in this example, for example, a moving image associated with the still image f1 included in the captured image is specified as a moving image started from a frame at a 30-second spot of a motion profile A. This is similarly applied to the other still images f2 to f7.

The moving image processing section 36 generates an AR reproduction moving image from each moving image specified by the moving image specifying section 34, that is, each moving image corresponding to each still image included in a captured image.

The moving image processing section 36 generates an AR reproduction moving image having a small file size by reducing a resolution or a bit rate of the moving image, for example, in order to reduce the file size of the moving image.

The first transmission section 38 transmits a variety of data including a moving image, a captured image, or the like between the server 12 and the portable terminal 14.

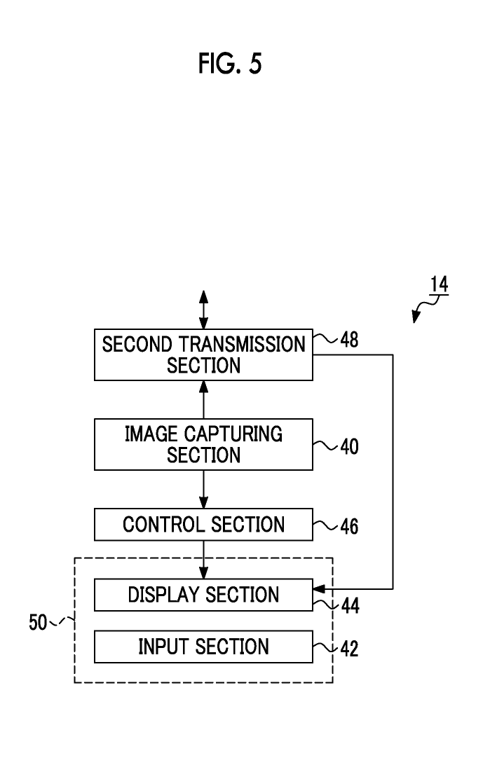

Subsequently, FIG. 5 is a block diagram illustrating an embodiment of an internal configuration of the portable terminal shown in FIG. 1. The portable terminal 14 is a smart phone, a tablet terminal or the like used by a user, and as shown in FIG. 5, includes an image capturing section 40, an input section 42, a display section 44, a control section 46, a second transmission section 48. The portable terminal 14 has a control device such as a CPU for example, which is not shown in the figure, and the CPU performs by loading various program thereon and controls capturing section 40, an input section 42, a display section 44, a control section 46, a second transmission section 48.

The image capturing section 40, which has a function as DSC (Digital Still Camera), captures an output image (AR print) of a composite image, for example, to acquire a captured image.

The input section 42 is a component through which various instructions are input from a user.

When an output image of a composite image is captured by the image capturing section 40, the display section 44 displays the captured output image of the composite image, and reproduces and displays each moving image associated with each still image included in the captured image, specified by the moving image specifying section 34 within an outline of each still image included in the displayed output image of the composite image. In this embodiment, it is assumed that a touch panel 50 forms the input section 42 and the display section 44.

The control section 46 performs a control, when an output image of a composite image is captured by the image capturing section 40, so that an AR reproduction moving image corresponding to the captured image is reproduced and displayed in the display section 44.

For example, the control section 46 performs a control so that each AR reproduction moving image generated from each moving image associated with each still image included in the captured image, specified by the moving image specifying section 34 within the outline of each still image included in the output image of the composite image displayed in the display section 44.

In this case, the control section 46 may perform a control so that the AR reproduction moving images generated from the respective moving images associated with the respective still images included in the captured image are reproduced at the same time, may perform a control so that the AR reproduction moving images generated from the respective moving images are reproduced one by one in a predetermined order, or may perform a control so that an AR reproduction moving image designated by a user among the AR reproduction moving images generated from the respective moving images is reproduced.

Further, when reproducing the moving image in the display section 44, the control section 46 may perform the reproduction using the AR technique (AR reproduction), or may perform the reproduction without using the AR technique (normal reproduction). When AR-reproducing the moving image, the control section 46 displays the captured output image in the display section 44, and performs a control so that the moving image is reproduced in a display portion of the output image displayed in the display section 44. Further, when normally reproducing the moving image, the control section 46 performs a control so that the moving image is reproduced on an entire surface of the display section 44 or in a window having an arbitrary size.

The second transmission section 48 transmits a variety of data including a moving image, a captured image, or the like between the portable terminal 14 and the server 12.

The printer 16 is an example of an output section of the invention that prints a composite image generated by the composite image generation section 22 to output an output image (printed matter).

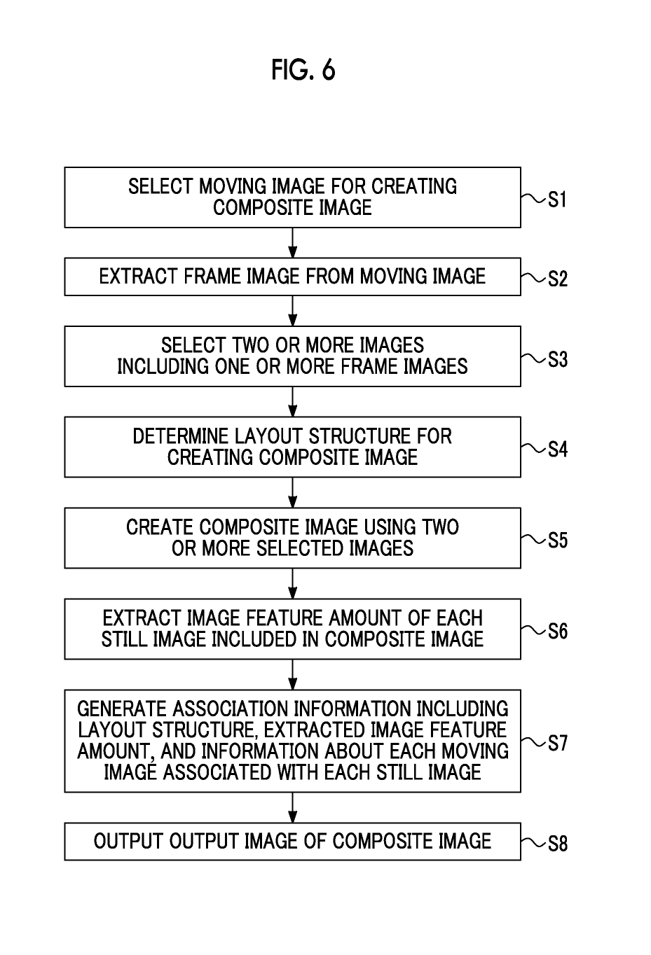

Next, an operation of the image processing device 10 when generating a composite image and association information and outputting an output image of the composite image will be described with reference to a flowchart shown in FIG. 6.

First, a user operates the touch panel 50 (input section 42) of the portable terminal 14 to select a moving image (moving image data) for creating a composite image, and inputs a transmission instruction of the selected moving image (step S1).

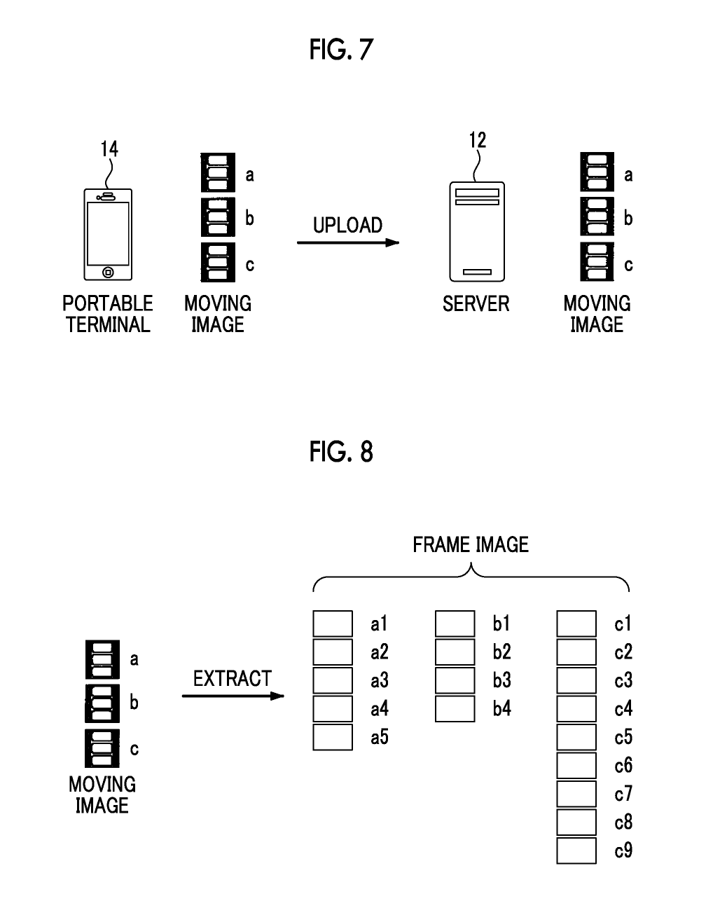

As shown in FIG. 7, the user inputs a transmission instruction of moving images a, b, and c, for example.

The moving images of which transmission is instructed are transmitted to the server 12 from the portable terminal 14 through the network 18 by the second transmission section 48. The server 12 receives the moving images transmitted from the portable terminal 14 through the first transmission section 38, and stores the received moving images in the storage section 32.

As shown in FIG. 7, the moving images a, b, and c are transmitted (uploaded) to the server 12 from the portable terminal 14, and are stored in the storage section 32.

Then, frame images (image data) are extracted from the moving images stored in the storage section 32 by the frame image extraction section 20, and thumbnail images (image data) of the extracted frame images are generated (step S2).

As shown in FIG. 8, for example, frame images a1 to a5 are extracted from the moving image a, frame images b1 to b4 are extracted from the moving image b, and frame images c1 to c9 are extracted from the moving image c.

The generated thumbnail images are transmitted to the portable terminal 14 from the server 12. In the portable terminal 14, the received thumbnail images are list-displayed on the touch panel 50 (display section 44).

Subsequently, the user operates the touch panel 50 (input section 42) to select two or more images including one or more thumbnail images from the thumbnail images list-displayed on the touch panel 50 (display section 44) and still images occupied by the user (step S3).

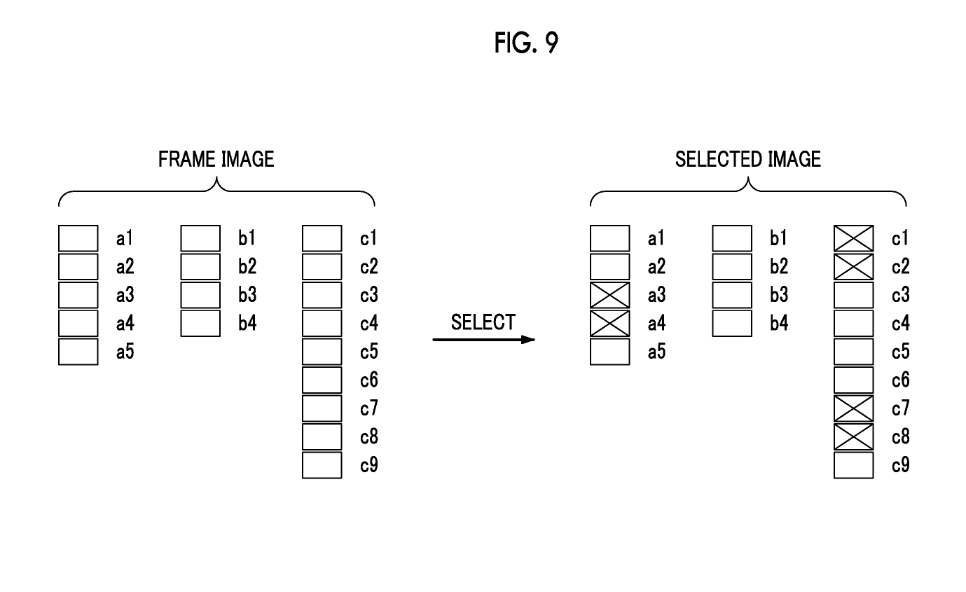

As shown in FIG. 9, for example, the thumbnail images of the frame images a1, a2, and a5 are selected from the thumbnail images of the frame images a1 to a5, the thumbnail images of the frame images b1 to b4 are selected from the thumbnail images of the frame images b1 to b4, and the thumbnail images of the frame images c3 to c6, and c9 are selected from the thumbnail images of the frame images c1 to c9.

Information about images including the selected thumbnail images is transmitted to the server 12 from the portable terminal 14. In the server 12, by the composite image generation section 22, frame images corresponding to the information about the received one or more thumbnail images are selected from among the frame images extracted from the moving images by the frame image extraction section 20, and two or more images including the selected one or more frame images are selected as selected images. Instead of the thumbnail images, the frame images extracted from the moving images may be used.

Then, the selected images (image data) are transmitted to the portable terminal 14 from the server 12. In the portable terminal 14, the received selected images are displayed on the touch panel 50 (display section 44) of the portable terminal 14.

Subsequently, the user operates the touch panel 50 (input section 42) to determine a layout structure for creating a composite image using the selected images, and to create a composite image such as a photo book or a collage print.

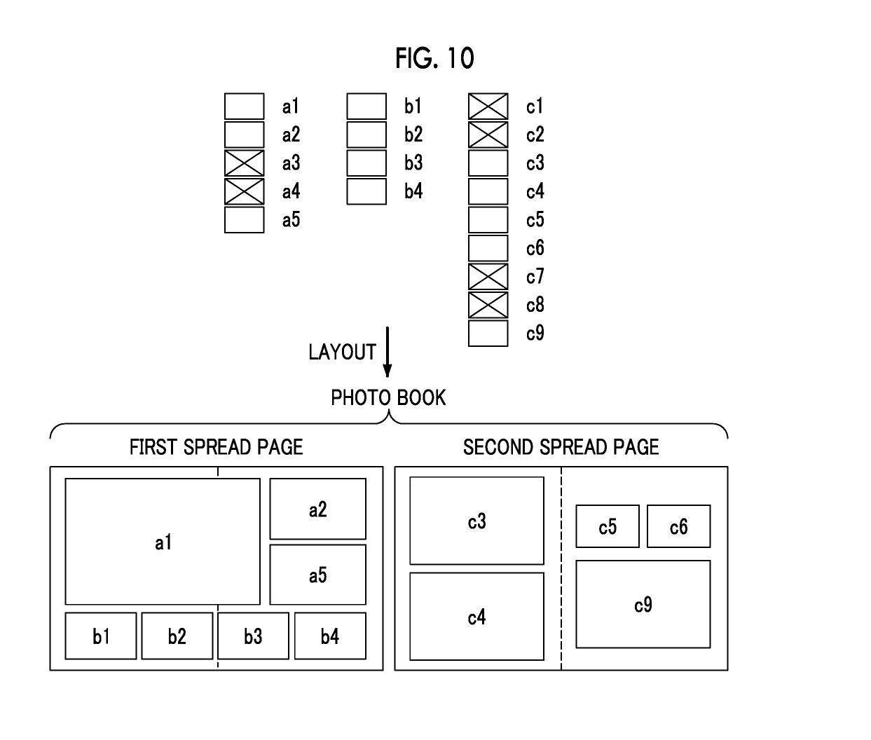

When the composite image is the photo book, selection of the number of pages and selection of a template to be used in the photo book (determination of a layout structure) are performed (step S4), and then, a layout editing process including image processing such as selection of arrangement positions of images, image correction, trimming, or enlargement, reduction or rotation of images is further performed. Subsequently, composite images on a first spread page and a second spread page of the photo book are created using the determined layout structure, as shown in FIG. 10, for example.

The layout structure used for generation of the composite images may be automatically generated from the number of selected images and aspect ratios of the selected images by the composite image generation section 22, or a user may select a layout structure having the same number of outlines as that of the number of selected images from among plural layout structures which are prepared in advance. That is, the layout structure of the composite images and the outline information are already known.

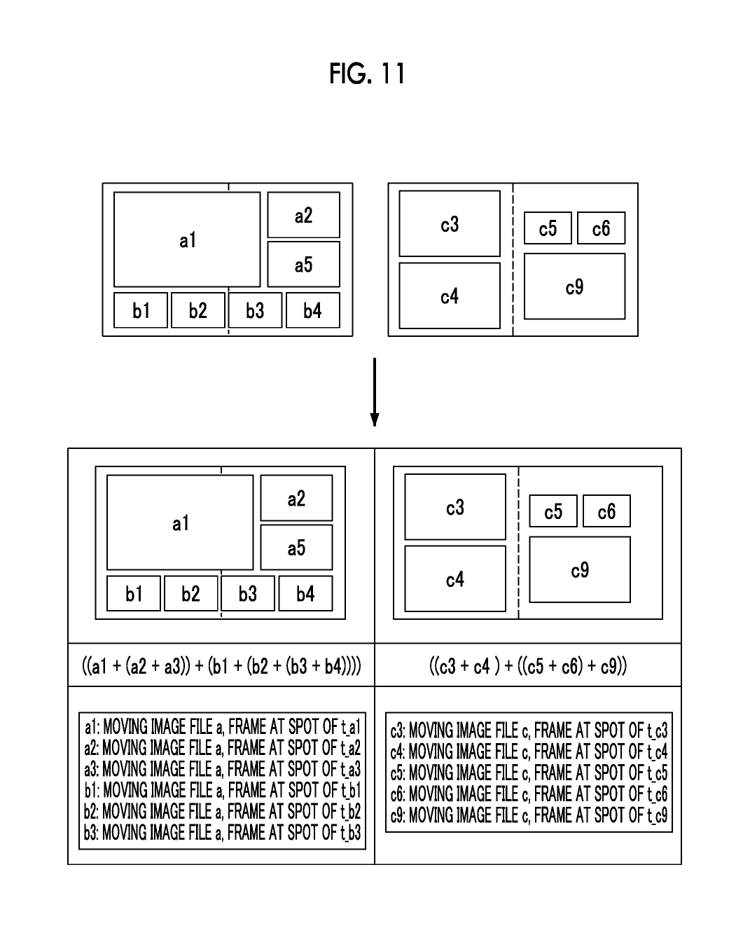

As shown in FIG. 11, for example, the layout structure of the composite image on the first spread page of the photo book is a logical structure of ((a1+(a2+a3))+(b1+(b2+(b3+b4)))), and the layout structure of the second spread page is a logical structure of ((c3+c4)+((c5+c6)+c9)).

Subsequently, information about the created composite images is transmitted to the server 12 from the portable terminal 14. In the server 12, the composite images are generated based on the information about the received composite images by the composite image generation section 22 (step S5). The composite images generated by the composite image generation section 22 are stored in the storage section 32.

Then, an image feature amount of each still image included in the composite images is extracted by the image feature amount extraction section 28 (step S6).

For example, a main color tone of the still images a1 and a2 included in the composite image on the first spread page of the photo book is green, a main color tone of the still image a3 is a water color, a main color tone of the still images b1, b2, and b4 is blue, and a main color tone of the still image b3 is red, a main color tone of the still images c3 and c9 included in the spread second page is a dark orange color, a main color tone of the still images c4 and c4 is a light orange color, and a main color tone of the still image c6 is yellow.

Then, the layout structure of the plural still images included in each composite image, an image feature amount of each still image included in the composite image, extracted by the image feature amount extraction section 28, and association information including information about each moving image associated with each still image included in the composite image are generated by the association information generation section 30 (step S7). The association information generated by the association information generation section 30 is stored in the storage section 32.

As shown in FIG. 11, for example, the moving image associated with the still image a1 included in the first spread page of the photo book starts from a frame at a spot of a time code t_a1 of the moving image file a. This is similarly applied to the other moving images.

Subsequently, the user operates the touch panel 50 (input section 42) to set a print size, the number of print sheets or the like, and inputs a print output instruction of a composite image.

The print output instruction is transmitted to the server 12 from the portable terminal 14. A composite image corresponding to the received print output instruction is transmitted to the printer 16 from the server 12, and an output image (printed matter) of the composite image is output by the printer 16 (step S8).

The output image of the composite image is delivered to the user.

As described above, the composite image and the association information are generated, and the output image of the composite image is output.

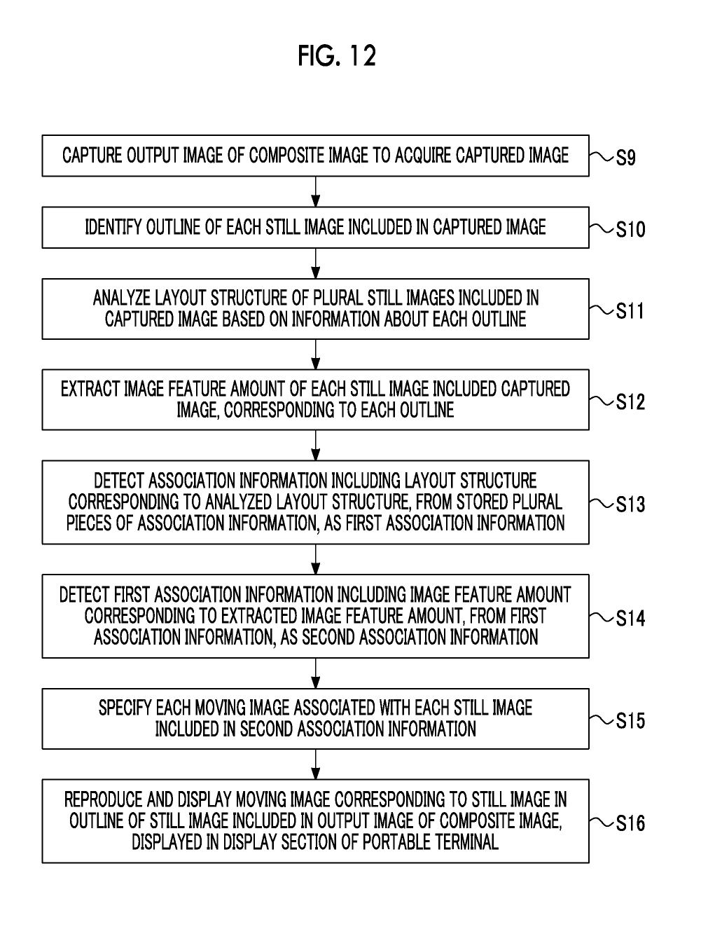

Next, an operation of the image processing device 10 when reproducing and displaying, when an output image of a composite image is captured by a user, an AR reproduction moving image corresponding to the output image will be described with reference to a flowchart shown in FIG. 12.

First, an output image (printed matter) of a composite image is captured by the image capturing section 40 to acquire a captured image (image data) (step S9). The captured output image of the composite image is displayed on the touch panel 50 (display section 44) of the portable terminal 14.

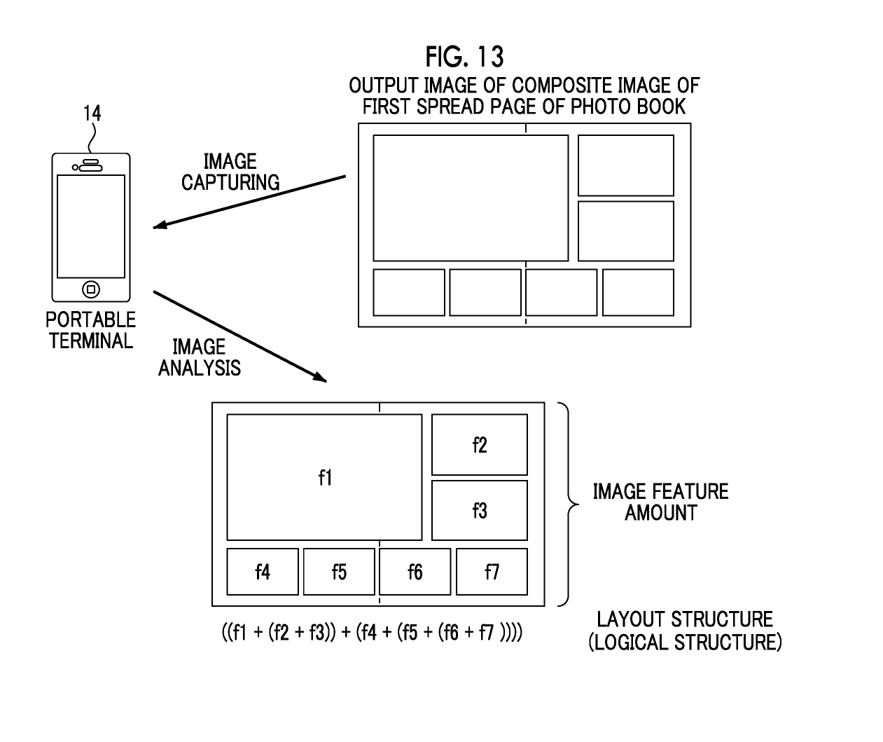

As shown in FIG. 13, for example, an output image of a composite image on a first spread page of a photo book is captured by the portable terminal 14 of the user.

The acquired captured image is transmitted to the server 12 from the portable terminal 14 through the network 18 by the second transmission section 48. The server 12 receives the captured image transmitted from the portable terminal 14 through the first transmission section 38.

After the captured image is received, an outline of each still image included in the captured image is identified by the outline identification section 24 (step S10).

As shown in FIG. 13, for example, it can be seen that seven still images f1 to f7 are included in the captured image. Further, arrangement positions, sizes, aspect ratios, and the like of the respective still images f1 to f7 are identified by the outline identification section 24.

Subsequently, a layout structure of the plural still images included in the captured image is analyzed by the layout structure analysis section 26 based on information about the respective outlines identified by the outline identification section 24 (step S11).

As shown in FIG. 13, for example, the layout structure of the captured image of the output image of the composite image on the first spread page of the photo book is a logical structure of ((f1+(f2+f3))+(f1+(f2+(f3+f4)))).

Further, an image feature amount of each still image included in the captured image, corresponding to each outline identified by the outline identification section 24 is extracted by the image feature amount extraction section 28 (step S12).

For example, it can be understood that a main color tone of the still images f1 and f2 included in the captured image of the output image of the composite image on the first spread page of the photo book is green, a main color tone of the still image f3 is a water color, a main color tone of the still images f4, f5, and f7 is blue, and a main color tone of the still image f6 is red.

Subsequently, the moving image specifying section 34 retrieves association information including a layout structure corresponding to the layout structure of plural still images included in the capture image, analyzed by the layout structure analysis section 26, from among plural pieces of association information of composite images stored in the storage section 32 and detects the result as first association information (step S13).

Then, first association information including an image feature amount corresponding to the image feature amount extracted by the image feature amount extraction section 28 is retrieved from the first association information, the result is detected as second association information (step S14), and each moving image associated with each still image included in the second association information is specified by the moving image specifying section 34 (step S15).

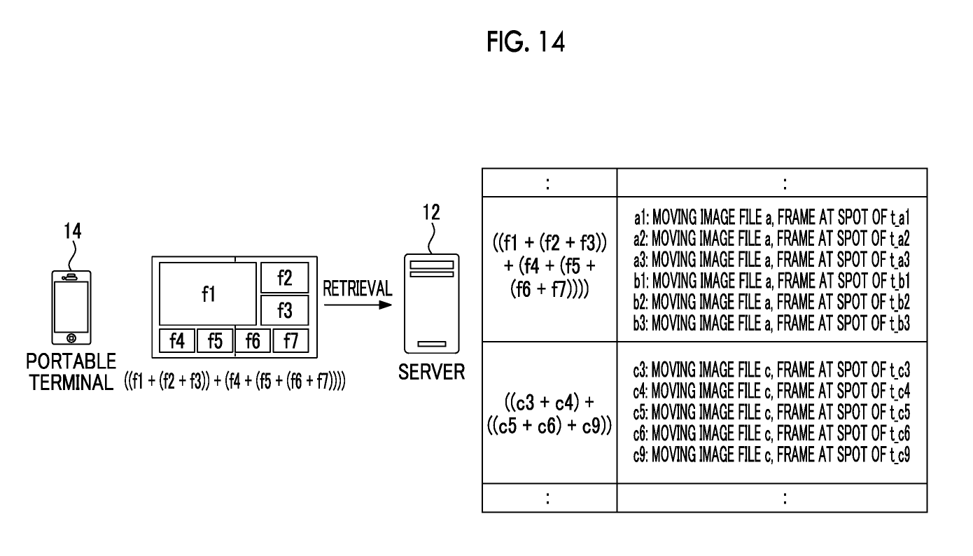

As shown in FIG. 14, association information including a logical structure corresponding to the logical structure of ((f1+(f2+f3))+(f1+(f2+(f3+f4)))) is retrieved as a layout structure from the plural pieces of association information of composite images stored in the storage section 32, and the result is detected as the first association information. Further, first association information including main color tones corresponding to green which is a main color tone of the still images f1 and f2, a water color which is a main color tone of the still image f3, blue which is a main color tone of the still images f4, f5, and f7, and red which is a main color tone of the still image f6 is retrieved from the first association information, and the result is detected as the second association information.

Subsequently, the moving image processing section 36 generates an AR reproduction moving image from each moving image corresponding to each still image included in the captured image, specified by the moving image specifying section 34.

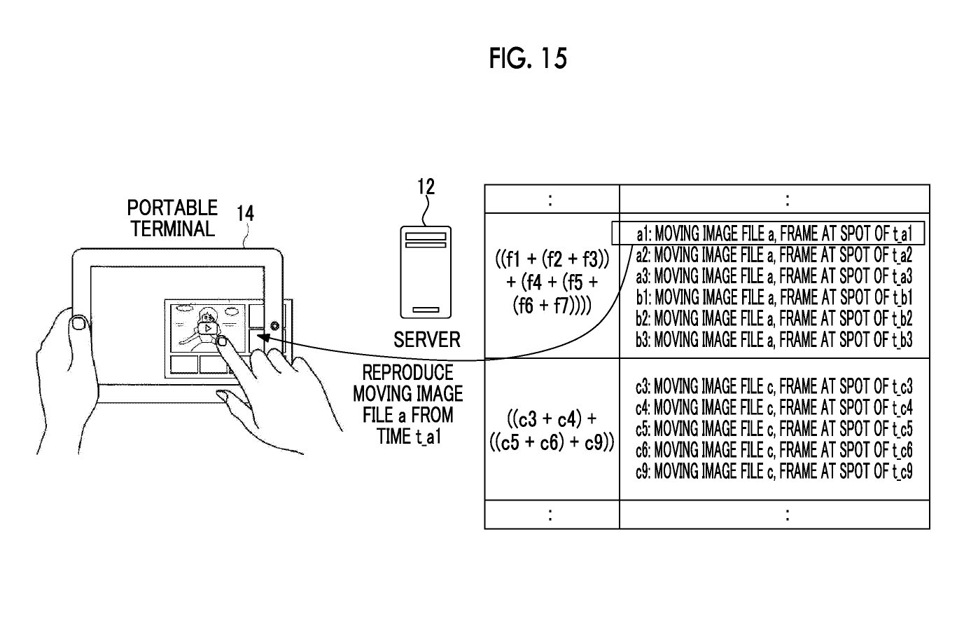

As shown in FIG. 15, for example, the moving image processing section 36 generates an AR reproduction moving image started from a frame at a spot of a time t_a1 of the moving image file a from the moving image associated with the still image a1 corresponding to the still image f1. This is similarly applied to the other moving images.

Then, the AR reproduction moving image generated by the moving image processing section 36 is transmitted to the portable terminal 14 from the server 12. The portable terminal 14 receives the AR reproduction moving image transmitted from the server 12.

After the AR reproduction moving image is received, each AR reproduction moving image generated from each moving image associated with each still image included in the captured image is reproduced and displayed in an outline of each still image included in the output image of the composite image, displayed on the touch panel 50 (display 44) of the portable terminal 14 under the control of the control section 46 (step S16).

As shown in FIG. 15, for example, if the still image f1 is designated by the user, the AR reproduction moving image generated from the moving image associated with the still image a1 corresponding to the still image f1 is transmitted to the portable terminal 14 from the server 12, and is reproduced and displayed in an outline of the still image f1.

As described above, if the output image of the composite image is captured, each moving image corresponding to each still image included in the captured image is specified, and the AR reproduction moving image generated from each moving image is reproduced and displayed by the portable terminal 14.

In the image processing device 10, by retrieving the association information using the layout structure of the plural still images included in the output image of the composite image, and the image feature amount of each still image, it is possible to specify the moving image corresponding to each still image. Thus, it is possible to greatly reduce time until a corresponding moving image is specified, compared with a case where a moving image corresponding to a still image is specified by performing similarity determination for the still images one by one, as in an image processing device in the related art.

Further, in the image processing device 10, by retrieving the association information using the layout structure and the image feature amount, it is possible to enhance the retrieval accuracy for specifying a corresponding moving image, compared with a case where moving images corresponding to still images are specified one by one, as in an image processing device in the related art. Thus, it is possible to save time for inputting an access key, to thereby enhance convenience. Further, since the retrieval accuracy is enhanced, the image feature amount extracted from each still image may be simpler than that in the related art.

It is not essential that the portable terminal 14 is used, and instead, a control apparatus such as a personal computer or the like including the image capturing section 40, the input section 42, the display section 44, the control section 46, the second transmission section 48, and the like may be used.

Further, it is not essential that the AR reproduction moving image is generated from the moving image by the moving image processing section 36, and instead, each moving image corresponding to each still image included in the captured image may be used as it is.

In addition, an example in which the image processing device 10 includes the server 12 and the portable terminal 14 is shown, but the invention is not limited thereto, and a configuration in which the server 12 and the portable terminal 14 are integrated may be used. Alternatively, the portable terminal 14 may include at least some components provided in the server 12, or contrarily, the server 12 may include at least some components provided in the portable terminal 14.

Further, the image feature amount extraction section 28 may divide each still image included in the captured image into two or more separate regions, and may extract an image feature amount of each separate region.

In this case, association information including information about the image feature amount of each separate region of each still image included in the composite image is stored in the storage section 32 in association with the composite image. Further, first association information including an image feature amount of each separate region corresponding to the image feature amount of each separate region extracted by the image feature amount extraction section 28 is retrieved from the first association information, and the result is detected as second association information, by the moving image specifying section 34.

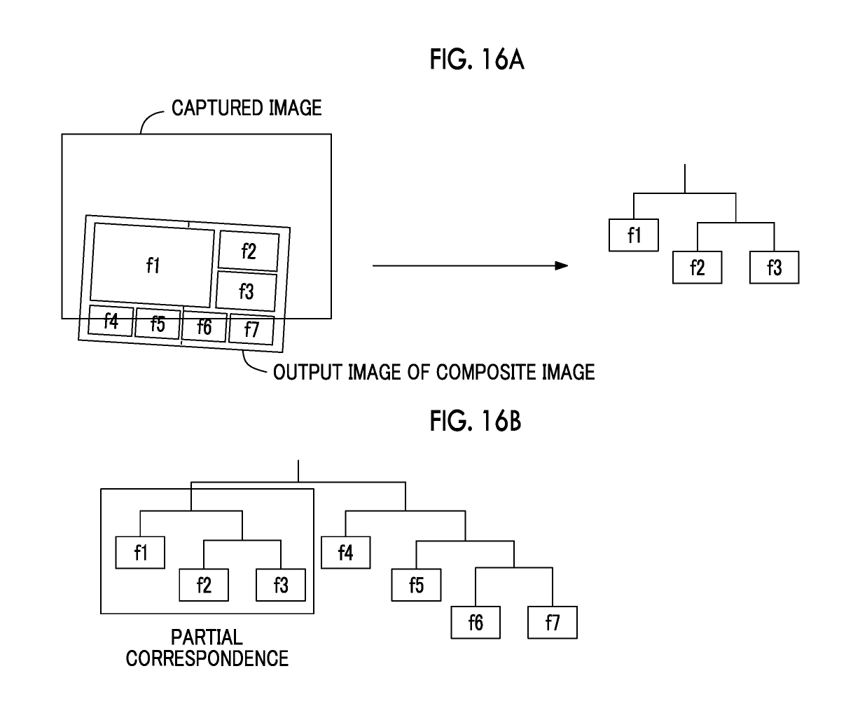

Further, as shown in FIG. 16A, when a captured image includes only some still images among plural still images included in an output image of the composite image, a moving image may be specified based on image feature amounts of only some still images included in the captured image.

In this case, the moving image specifying section 34 retrieves association information including a layout structure corresponding to a layout structure of only the portion of still images analyzed by the layout structure analysis section 26, from plural pieces of association information of the composite images stored in the storage section 32 and detects the result as the first association information. Further, the moving image specifying section 34 retrieves first association information including image feature amounts corresponding to the image feature amounts of only some still images extracted by the image feature amount extraction section 28, from the first association information, and detects the result as the second association information.

For example, as shown in FIG. 16A, when only three still images f1 to f3 are captured in a captured image while seven still images f1 to f7 are included in the output image of the composite image, the moving image specifying section 34 retrieves association information including a layout structure corresponding to a layout structure of only the portion of three still images f1 to f3 as shown in FIG. 16B and detects the result as first association information. Further, the moving image specifying section 34 retrieves first association information including image feature amounts corresponding to the image feature amounts of the three still images f1 to f3 and detects the result as second association information.

For example, when some still images among plural still images included in an output image of a composite image are not visible due to glare or the like, similarly, it is possible to specify moving images based on image feature amounts of the only remaining still images capable of being visible.

Further, the moving image specifying section 34 specifies the moving image using both of the layout structure and the image feature amount, but the invention is not limited thereto. For example, the moving image specifying section 34 may specify the moving image using only the layout structure or only the image feature amounts of the plural still images.

For example, when the moving image is specified using only the layout structure, association information including the layout structure of the plural still images included in the composite image and information about each moving image associated with each still image included in the composite image is stored in the storage section 32 in association with the composite image. Further, association information including a layout structure corresponding to the layout structure of the plural still images included in the captured image, analyzed by the layout structure analysis section 26, is retrieved from plural pieces of association information of composite images stored in the storage section 32 by the moving image specifying section 34, and the result is detected as first association information, and each moving image associated with each still image included in the first association information is specified.

The device of the invention may be configured so that the respective components of the device are formed by exclusive-use hardware, or may be configured by a computer in which the respective components are programmed.

The method of the invention may be executed by a program that causes a computer to execute respective steps thereof, for example. Further, a computer-readable recording medium that stores the program may also be provided.

Hereinabove, the invention has been described in detail, but the invention is not limited to the above-described embodiments, and may include various improvements or modifications in a range without departing from the spirit of the invention.

What is claimed is:

1. An image processing device comprising:
an outline identification section that identifies an outline of each still image included in a captured image acquired by capturing an output image of a composite image including a plurality of still images;
a layout structure analysis section that analyzes a layout structure of the plurality of still images included in the captured image based on information about each outline identified by the outline identification section;
a storage section that stores association information including the layout structure of the plurality of still images included in the composite image and information about each moving image associated with each still image included in the composite image, in association with the composite image; and
a moving image specifying section that retrieves association information including a layout structure corresponding to the layout structure of the plurality of still images included in the captured image, analyzed by the layout structure analysis section, from a plurality of pieces of association information of composite images stored in the storage section, detects the result as first association information, and specifies each moving image associated with each still image included in the first association information.

2. The image processing device according to claim 1, further comprising:
an image feature amount extraction section that extracts an image feature amount of each still image included in the captured image, corresponding to each outline identified by the outline identification section,
wherein the storage section further stores association information including information about the image feature amount of each still image included in the composite image in association with the composite image, and
wherein the moving image specifying section further retrieves, from the first association information, first association information including an image feature amount corresponding to the image feature amount extracted by the image feature amount extraction section, detects the result as second association information, and specifies each moving image associated with each still image included in the second association information.

3. The image processing device according to claim 2,
wherein the image feature amount extraction section divides each still image included in the captured image into two or more separate regions and extracts an image feature amount of each separate region,
wherein the storage section stores association information including information about the image feature amount of each separate region of each still image included in the composite image, in association with the composite image, and
wherein the moving image specifying section retrieves, from the first association information, first association information including an image feature amount of each separate region corresponding to the image feature amount of each separate region extracted by the image feature amount extraction section and detects the result as second association information.

4. The image processing device according to claim 1,
wherein when the captured image includes only some still images among the plurality of still images included in the output image of the composite image, the moving image specifying section retrieves association information including a layout structure corresponding to a layout structure of only the portion of still images analyzed by the layout structure analysis section, from the plurality of pieces of association information of composite images stored in the storage section, and detects the result as first association information.

5. The image processing device according to claim 2,
wherein in case where the captured image includes only some still images among the plurality of still images included in the output image of the composite image, the moving image specifying section retrieves association information including a layout structure corresponding to a layout structure of only the portion of still images analyzed by the layout structure analysis section, from the plurality of pieces of association information of composite images stored in the storage section, and detects the result as first association information, and retrieves, from the first association information, first association information including image features amounts corresponding to image feature amounts of only the portion of still images extracted by the image feature amount extraction section and detects the result as second association information.

6. The image processing device according to claim 1, further comprising:
a frame image extraction section that extracts a plurality of frame images from a moving image;
a composite image generation section that generates the composite image using two or more images including one or more frame images selected from among the plurality of frame images extracted by the frame image extraction section; and
an output section that prints the composite image generated by the composite image generation section to output an output image.

7. The image processing device according to claim 6, further comprising:
an association information generation section that generates, in case where the composite image is generated by the composite image generation section, the association information including the layout structure of the plurality of still images included in the composite image and the information about each moving image associated with each still image included in the composite image,
wherein the storage section stores the association information generated by the association information generation section in association with the composite image.

8. The image processing device according to claim 2, further comprising:
a frame image extraction section that extracts a plurality of frame images from a moving image;
a composite image generation section that generates the composite image using two or more images including one or more frame images selected from among the plurality of frame images extracted by the frame image extraction section; and
an output section that prints the composite image generated by the composite image generation section to output an output image.

9. The image processing device according to claim 8,
wherein the image feature amount extraction section further extracts, in case where the composite image is generated by the composite image generation section, an image feature amount of each still image included in the composite image,
the image processing device further comprising:
an association information generation section that generates, in case where the composite image is generated by the composite image generation section, the association information including the layout structure of the plurality of still images included in the composite image, the image feature amount of each still image included in the composite image, extracted by the image feature amount extraction section, and the information about each moving image associated with each still image included in the composite image,
wherein the storage section stores the association information generated by the association information generation section in association with the composite image.

10. The image processing device according to claim 2,
wherein the image feature amount extraction section extracts at least one of a main color tone, luminance, blurring, edges, and a subject person of each still image, as the image feature amount.

11. The image processing device according to claim 1,
wherein the outline identification section identifies characteristics of the outlines including the number of the outlines, and an arrangement position, a size, and an aspect ratio of each outline.

12. The image processing device according to claim 1,
wherein the layout structure analysis section sequentially divides the plurality of still images included in the composite image and the captured image using a binary tree to create a tree structure, to analyze the layout structure.

13. The image processing device according to claim 1, further comprising:
an image capturing section that captures the output image of the composite image to acquire the captured image;
a display section that displays, in case where the output image is captured by the image capturing section, the output image; and
a control section that performs a control so that in case where the output image is captured by the image capturing section, each moving image associated with each still image included in the captured image, specified by the moving image specifying section, is reproduced in the outline of each still image included in the output image displayed in the display section.

14. The image processing device according to claim 13,
wherein the control section performs a control so that in case where the output image is captured by the image capturing section, the output image is displayed in the display section and the respective moving images associated with the respective still images, specified by the moving image specifying section, are reproduced at the same time in the outlines of the respective still images included in the output image displayed in the display section.

15. The image processing device according to claim 13,
wherein the control section performs a control so that in case where the output image is captured by the image capturing section, the output image is displayed in the display section and the respective moving images associated with the respective still images included in the captured image, specified by the moving image specifying section, are reproduced one by one in a predetermined order in the outlines of the respective still images included in the output image displayed in the display section.

16. The image processing device according to claim 13,
wherein the control section performs a control so that in case where the output image is captured by the image capturing section, the output image is displayed in the display section and a moving image designated by a user among the respective moving images associated with the respective still images included in the captured image, specified by the moving image specifying section, is reproduced in the outline of each still image included in the output image displayed in the display section.

17. An image processing method using the image processing device according to claim 1, comprising:
identifying an outline of each still image included in a captured image acquired by capturing an output image of a composite image including a plurality of still images, by an outline identification section;
analyzing a layout structure of the plurality of still images included in the captured image based on information about each outline identified by the outline identification section, by a layout structure analysis section; and
retrieving association information including a layout structure corresponding to the layout structure of the plurality of still images included in the captured image, analyzed by the layout structure analysis section, from a plurality of pieces of association information of composite images stored in a storage section that stores association information including the layout structure of the plurality of still images included in the composite image and information about each moving image associated with each still image included in the composite image, in association with the composite image, detecting the result as first association information, and specifying each moving image associated with each still image included in the first association information, by a moving image specifying section.

18. The image processing method according to claim 17, further comprising:
extracting an image feature amount of each still image included in the captured image, corresponding to each outline identified by the outline identification section, by an image feature amount extraction section,
wherein the storage section further stores association information including information about the image feature amount of each still image included in the composite image in association with the composite image, and
wherein the moving image specifying section further retrieves, from the first association information, first association information including an image feature amount corresponding to the image feature amount extracted by the image feature amount extraction section, detects the result as second association information, and specifies each moving image associated with each still image included in the second association information.

19. The image processing method according to claim 18,
wherein the image feature amount extraction section divides each still image included in the captured image into two or more separate regions and extracts an image feature amount of each separate region,
wherein the storage section stores association information including information about the image feature amount of each separate region of each still image included in the composite image, in association with the composite image, and
wherein the moving image specifying section retrieves, from the first association information, first association information including an image feature amount of each separate region corresponding to the image feature amount of each separate region extracted by the image feature amount extraction section and detects the result as second association information.

20. The image processing method according to claim 17,
wherein in case where the captured image includes only some still images among the plurality of still images included in the composite image, the moving image specifying section retrieves association information including a layout structure corresponding to a layout structure of only the portion of still images analyzed by the layout structure analysis section, from the plurality of pieces of association information of composite images stored in the storage section, and detects the result as first association information.

21. The image processing method according to claim 18,
wherein in case where the captured image includes only some still images among the plurality of still images included in the composite image, the moving image specifying section retrieves association information including a layout structure corresponding to a layout structure of only the portion of still images analyzed by the layout structure analysis section, from the plurality of pieces of association information of composite images stored in the storage section, and detects the result as first association information, and retrieves, from the first association information, first association information including image features amounts corresponding to image feature amounts of only the portion of still images extracted by the image feature amount extraction section and detects the result as second association information.

22. A computer-readable recording medium that stores a program that causes a computer to execute the steps of the image processing method according to claim 17.
